(19) United States
(12) Patent Application Publication
(10) Pub. No.: US 2015/0101585 A1
(43) Pub. Date: Apr. 16, 2015

(54) CAMPFIRE COOKING ASSEMBLY

(71) Applicants: Chris Kreschmer, Eastpointe, MI (US); Jacqueline Kreschmer, Eastpointe, MI (US); Krystin Kreschmer, Eastpointe, MI (US)

(72) Inventors: Chris Kreschmer, Eastpointe, MI (US); Jacqueline Kreschmer, Eastpointe, MI (US); Krystin Kreschmer, Eastpointe, MI (US)

(21) Appl. No.: 14/050,547

(22) Filed: Oct. 10, 2013

(51) Int. Cl. A47J 33/00

(52) U.S. Cl. CPC A47J 33/00
USPC 126/30

(57) ABSTRACT

A campfire cooking assembly for placement over a campfire that includes: a first vertical post and a second vertical post. The vertical posts are mounted on each side of an open campfire and include adjustable brackets on each post. The brackets may be adjustable vertically along the posts and receive a cooking mechanism between the brackets. Each post further includes a stake at the bottom that is used to drive the posts into the ground. Bolts may be provided on each bracket as a means to adjust the height of the bracket and in one particular, a rotating motor is provided on one vertical post. The brackets are adapted to receive a cooking mechanism such as a rotisserie rod or a cooking plate that may be inserted into the brackets for cooking purposes.

### BACKGROUND OF THE INVENTION

1. Field of Invention

The present invention relates to a campfire cooking assembly used to prepare and cook food over an open campfire.

2. Description of Related Art

Many individuals on camping and hiking trips prepare food over a fire pit. This open-pit cooking can be challenging in some aspects due to the elements that may be existing at the campsite. Overall individuals must have some type of device or equipment to hold the food over the open fire while cooking Further there must be a means to contain the fire in a particular area to avoid injury while cooking the food. Some aspects of open campfire cooking include equipment that is developed that has been used in association with the open campfire. It is advantageous to have a device that could be arranged over the fire and capable of holding or supporting any meat or dishes over the open fire. Also to control temperature it would be advantageous to have a device that could be adjusted vertically while working over a campfire.

### SUMMARY OF THE INVENTION

The present invention relates to a campfire cooking assembly that includes a first vertical post and a second vertical post. The vertical posts are mounted on each side of an open campfire and include adjustable brackets on each post. The brackets may be adjustable vertically along the posts and receive a cooking mechanism between the brackets. Each post further includes a stake at the bottom that is used to drive the posts into the ground. Bolts may be provided on each bracket as a means to adjust the height of the bracket and in one particular, a rotating motor is provided on one vertical post. The brackets are adapted to receive a cooking mechanism such as a rotisserie rod or a cooking plate that may be inserted into the brackets for cooking purposes.

### BRIEF DESCRIPTION OF DRAWINGS

FIG. 1 illustrates components associated with a campfire cooking assembly in accordance with the present invention.

FIG. 2 depicts use of the campfire cooking assembly over a open campfire.

### DETAILED DESCRIPTION

The present invention relates to a campfire cooking assembly that is used to prepare foods and particulars meats over an open campfire. The assembly includes two posts a first post and a second post that are arranged on each side of the campfire. Adjustable brackets are provided on each post that may be vertically adjusted to adjust the height of the cooking mechanism. A stake is provided at the bottom of each post to drive the posts into the ground. Bolts may be provided on each bracket that allow the user to adjust the height of the brackets and therefore adjust the height of the cooking mechanism. The cooking mechanism in one particular embodiment may be a rotisserie rod that is engaged into a rotating motor on one of the vertical posts. The rod is received on the opposite end by receiving a brace on the second vertical post.

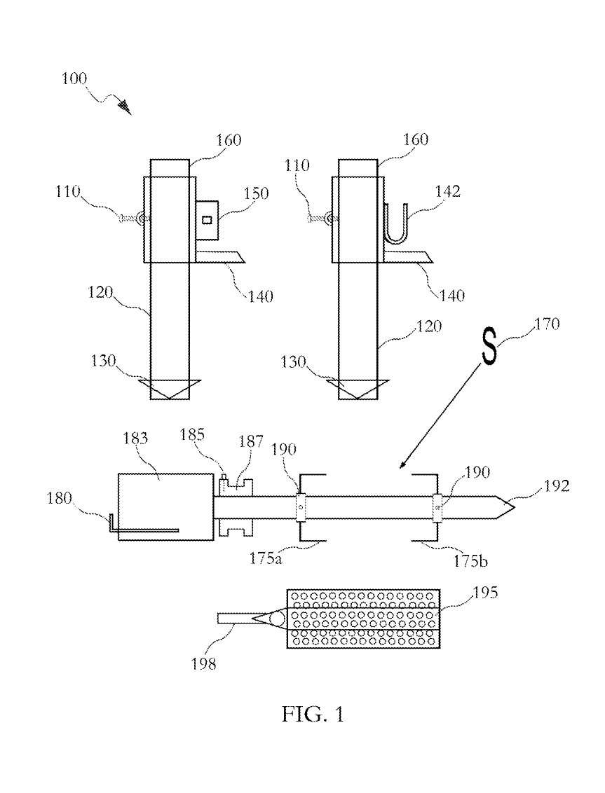

With respect to FIG. 1, the various components of a campfire cooking assembly 100 are depicted. The cooking assembly 100 includes posts 120, a first vertical post and a second vertical post. Each post 120 includes a stake 130 at each end of the post to drive the posts into the ground. Brackets 160 are provided on each post 120. The brackets 160 include a heat shield 140. The heat shield 140 extends vertically from the bracket 160. One particular bracket, the first vertical post, includes a rotating motor 150. The second vertical post includes a receiving brace 142. The brackets 160 may be maneuvered along the vertical length of the post 120 by the use of a bolt 110.

Further shown in FIG. 1 are cooking mechanisms that are engaged in the brackets 160 of the vertical posts 120. Initially a rotisserie rod 192 is shown. The rotisserie rod 192 includes a gearbox 183 that engages with the motor 150 shown on the first vertical post. Just inside of the gearbox is a bearing 187 that is locked into place with a set pin 185. Also provided is an allen wrench 180 that is received into a opening of the gearbox 183. Further skewers 175a, 175b are depicted that are locked into place with set pins 190 that enable the movement of the skewers over the length of the rod 192. These skewers may be adjusted to engage various types of meat that is placed upon the rotisserie rod 192. In addition to rotisserie rod 192 another cooking mechanism is provided, a cooking plate 195 includes a mounting post 198 that may engage into the motor 150 of the first vertical post.

Also shown in FIG. 1 is a S-hook 170. The S-hook 170 provides a means to place a Dutch oven onto the rotisserie rod 192. This placement of the Dutch oven over the campfire 150 enables outdoor enthusiasts to have several options to utilize with the campfire cooking assembly in accordance with the present invention.

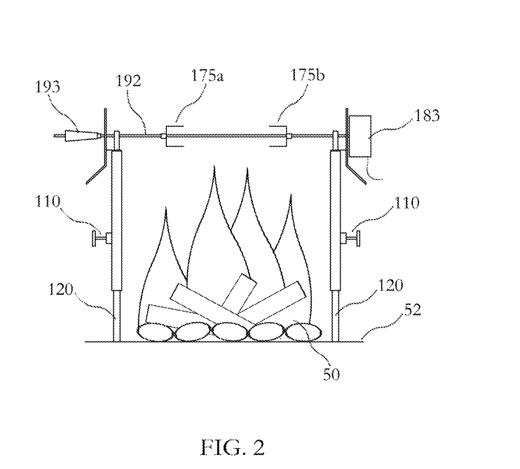

FIG. 2 depicts use of the campfire cooking assembly 100 over a campfire 50. Each vertical post 120 is driven into a ground surface 52. The vertical posts 120 are supporting the rotisserie rod 192, where the height of the rotisserie rod 192 may be adjusted by movement of the brackets 160 which are engaged into the vertical posts with the bolts of 110.

What is claimed is:

1. The campfire cooking assembly comprising:
a first vertical post;
a second vertical post;
an adjustable bracket on each post, where each the height of each bracket may be adjusted vertically and the brackets are adapted to receive a cooking mechanism;
a stake at the bottom end of each post;
a locking bolt for each bracket;
a rotating motor on the first vertical post; and a receiving brace on the second vertical post.

2. A campfire cooking assembly according to claim 1, where the cooking mechanism includes:
a rod, extending between the adjustable brackets;
a pair of skewers on the rod;
a gearbox at one end of the rod; and
a bearing on the inside of the gearbox.

3. The campfire cooking assembly according to claim 2, where a first set pin is provided to set the horizontal position of the bearing on the rod.

4. The campfire assembly according to claim 2, where a set pin is provided for each skewer to adjust the position of each skewer on the rotisserie rod.

5. The campfire assembly according to claim 1 where the cooking mechanism is a flat cooking plate where the flat cooking plate includes a post that engaged the motor of the first vertical post.
